(19) United States
(12) Patent Application Publication
(10) Pub. No.: US 2006/0081707 A1
(43) Pub. Date: Apr. 20, 2006

(54) Monitor having a card reader

(75) Inventor: Teng-Fah Yang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/998,604

(22) Filed: Nov. 30, 2004

(30) Foreign Application Priority Data
Oct. 18, 2004 (TW) 093131515

(51) Int. Cl. G06K 7/06

(52) U.S. Cl. 235/441

(57) ABSTRACT

Disclosed is a monitor, which has a recessed open chamber in the base of the stand thereof, and a card reader module pivotally mounted in the recessed open chamber and turnable relative to the base in and out of the recessed open chamber between the recessed position and the extended position.

### BACKGROUND OF THE INVENTION

1. Field of the Invention

The present invention relates to a monitor for computer and more particularly, to a monitor with a card reader.

2. Description of Related Art

A variety of memory cards are commercially available. There are also commercially available card readers for reading different memory cards. Regular card readers are made in a mobile form attachable to a computer system or LCD TV. When attached a mobile card reader to a computer system or LCD TV, the mobile card reader is exposed to the open air, and the insertion slot of the card reader tends to be covered with dust. Further, using a mobile card reader with a computer system or LCD TV requires an extra installation space, and the attached mobile card reader destroys the sense of beauty of the outer appearance of the computer system or LCD TV.

### SUMMARY OF THE INVENTION

The present invention has been accomplished under the circumstances in view. According to one aspect of the present invention, the monitor comprises a stand, which has a base and an upright upwardly extending from the top of the base, and a display screen provided at the top of the upright, wherein the base comprises a recessed open chamber, first pivot means provided inside the recessed open chamber, a card reader module, and second pivot means provided at the card reader module and pivotally coupled to the first pivot means to secure the card reader module to the recessed open chamber for enabling the card reader module to be turned relative to the base between a first position where the card reader module is received inside the recessed open chamber and a second position where the card reader module has the memory card insertion slots thereof exposed to the outside of the recessed open chamber. According to another aspect of the present invention, the stand further comprises first retaining means disposed inside the recessed open chamber, and second retaining means provided at the card reader module and adapted to engage the first retaining means when the user turned the card reader module to the first position. According to still another aspect of the present invention, the stand further comprises spring means provided between the recessed open chamber and the card reader module and adapted to move the card reader module from the first position to the second position.

Further, the monitor can be a LCD screen, plasma display screen, CRT display screen, or any of a variety of equivalent display means.

### BRIEF DESCRIPTION OF THE DRAWINGS

FIG. 1 is a perspective view of the preferred embodiment of the present invention.

FIG. 2 is a schematic view in an enlarged scale of a part of the preferred embodiment of the present invention.

FIG. 3 is a schematic exploded view of a part of the preferred embodiment of the present invention.

### DETAILED DESCRIPTION OF THE PREFERRED EMBODIMENT

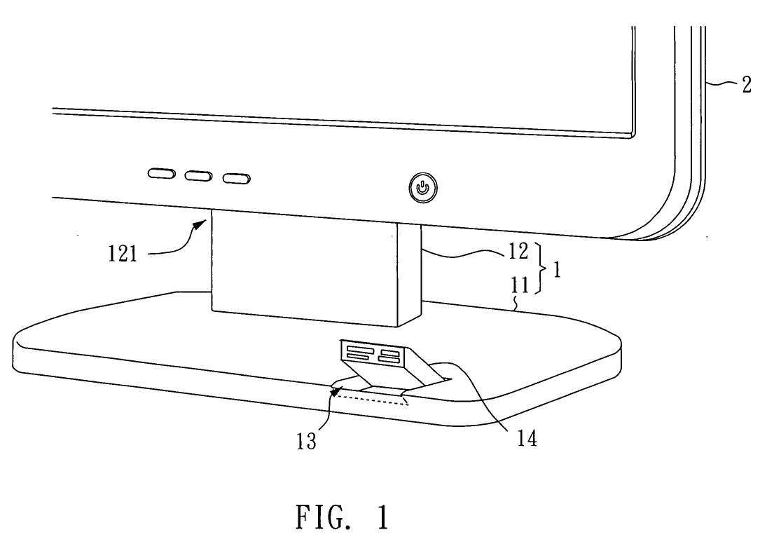

Referring to FIG. 1, a monitor is shown comprising a liquid crystal display screen 2 and a stand 1. The stand 1 has a base 11 and an upright 12. The upright 12 is provided at the top side of the base 11. The liquid crystal display screen 2 is provided at the top 121 of the upright 12. The base 11 comprises a recessed open chamber 13 and a card reader module 14.

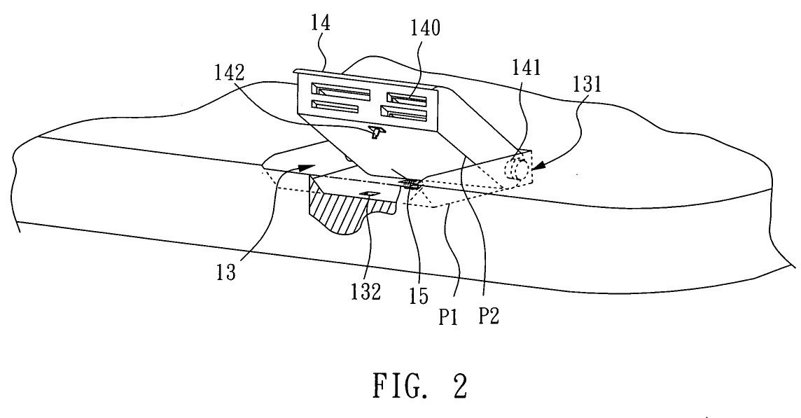

Referring to FIG. 2 and FIG. 1 again, the base 11 has two pivot holes 131 bilaterally provided inside the recessed open chamber 13 and horizontally aligned in line. The card reader module 14 has a plurality of insertion slots 140 in the front side for the insertion of different memory cards, and two pivot pins 141 symmetrically provided at the two opposite lateral sidewalls near the rear side and respectively pivotally coupled to the pivot holes 131 in the recessed open chamber 13 of the base 11 for enabling the card reader module 14 to be turned relative to the base 11 between a first position P1 where the card reader module 14 is received inside the recessed open chamber 13 of the base 11 and a second position P2 where the insertion slots 140 are exposed to the outside of the base 11 for enabling the user to insert a memory card into one of the insertion slots 140.

The base 11 has a female retaining portion 132 provided inside the recessed open chamber 13. The card reader module 14 has a male retaining portion 142 corresponding to the female retaining portion 132. When turned the card reader module 14 to the first position P1, the male retaining portion 142 engages the female retaining portion 132 to hold the card reader module 14 firmly in the first position P1. Further, a spring member 15 is provided between the card reader module 14 and the recessed open chamber 13. The spring member 15 imparts an upward spring force to the card reader module 14 to move the card reader module 14 from the first position P1 to the second position P2.

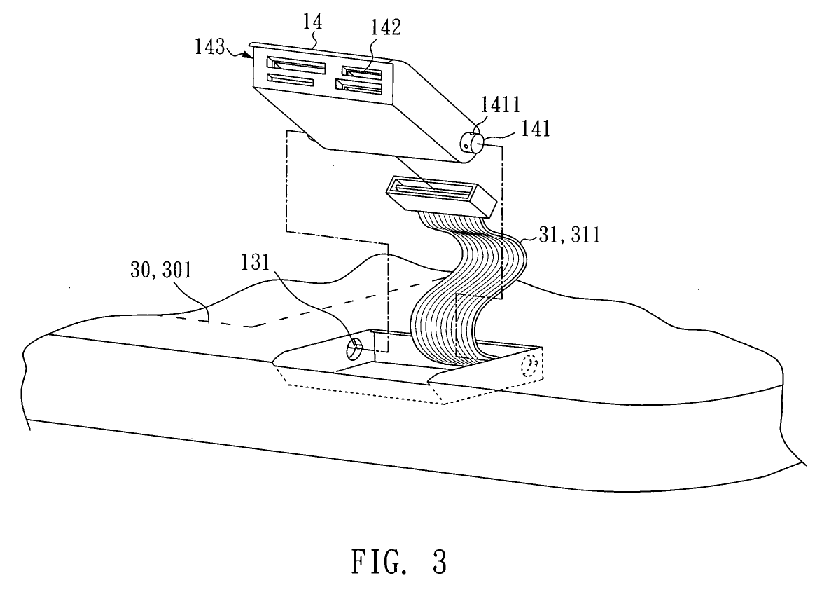

Referring to FIG. 3, each pivot pin 141 of the card reader module 14 has a raised portion 1411 at the periphery; the base 11 has a protruding stop portion 1311 in each pivot hole 131. When turned the card reader module 14 to the second position, the raised portion 1411 of each pivot pin 141 is stopped at the protruding stop portion 1311 in the corresponding pivot hole 131. A control device 30 is mounted inside the stand 1, having a control circuit 31 electrically connected to the card reader module 14. According to the present preferred embodiment, the control device 30 is a circuit board 301, and the control circuit 31 is a flexible bus line 311. Further, a finger strip 143 is provided at the front side of the card reader module 14 for gripping with the fingers to turn the card reader module 14 from the first position P1 to the second position P2.

Although the present invention has been explained in relation to its preferred embodiment, it is to be understood that many other possible modifications and variations can be made without departing from the spirit and scope of the invention as hereinafter claimed.

1. A monitor comprising a stand, said stand having a base and an upright upwardly extending from a top side of said base, and a display screen provided at the topmost edge of said upright, wherein said base comprises a recessed open chamber, first pivot means provided inside said recessed open chamber, a card reader module, said card reader module having at least one insertion slot for the insertion of a memory card, and second pivot means provided at said card reader module and pivotally coupled to said first pivot means to secure said card reader module to said recessed open chamber for enabling said card reader module to be turned relative to said base between a first position where said card reader module is received inside said recessed open chamber and a second position where said card reader module has the at least one insertion slot thereof exposed to the outside of said recessed open chamber,
wherein said stand further comprises first retaining means disposed inside said recessed open chamber, and second retaining means provided at said card reader module and adapted to engage said first retaining means when the user turns said card reader module to said first position.

2. (canceled)

3. The monitor as claimed in claim 1, wherein said stand further comprises spring means provided between said recessed open chamber and said card reader module and adapted to move said card reader module from said first position to said second position.

4. The monitor as claimed in claim 1, wherein said first pivot means comprises two pivot holes horizontally aligned in said recessed open chamber at two sides; said second pivot means comprises two pivot pins respectively provided at two opposite sides of said card reader module.

5. The monitor as claimed in claim 4, wherein each said pivot pin comprises a raised portion at the periphery thereof; each said pivot hole has a protruding stop portion adapted to stop the raised portion at the corresponding pivot pin when the user turns said card reader module from said first position to said second position.

6. The monitor as claimed in claim 1, wherein said stand further comprises a control device and a control circuit connected between said control device and said card reader module.

7. The monitor as claimed in claim 6, wherein said control device is a circuit board, and said control circuit is a flexible bus line.

8. The monitor as claimed in claim 1, wherein said card reader module has a finger strip at a front side thereof.
